(19) United States
(12) Patent Application Publication
(10) Pub. No.: US 2014/0234064 A1
(43) Pub. Date: Aug. 21, 2014

(54) Sealing System, An Industrial Robot With A Sealing System, And Method For Providing A Sealing Surface

(71) Applicants: Shanghua Li, Vasteras (SE); Arne Broberg, Vasteras (SE); Erik Johansson, Vasteras (SE); Ake Oberg, Uppsala (SE)

(72) Inventors: Shanghua Li, Vasteras (SE); Arne Broberg, Vasteras (SE); Erik Johansson, Vasteras (SE); Ake Oberg, Uppsala (SE)

(21) Appl. No.: 14/266,339

(22) Filed: Apr. 30, 2014

Related U.S. Application Data
(63) Continuation of application No. PCT/EP2011/070729, filed on Nov. 23, 2011.

(51) Int. Cl. F16J 15/32; B25J 11/00

(52) U.S. Cl. CPC F16J 15/324; B25J 11/00
USPC 414/729; 277/569; 277/309

(57) ABSTRACT

A sealing system including a rotary sealing surface on a rotary shaft and a rotary shaft lip seal, of which the rotary sealing surface has a surface coating layer of a solid lubricant substance. The invention further includes an industrial robot having several axes of rotation, including a manipulator with drive units for rotating robot parts according to the axes of rotation of the robot, and at least one of the drive units having a rotary shaft provided with such a sealing system. In addition, the invention includes a method for providing a rotary sealing surface on a rotary shaft, including coating the intended sealing surface of the rotary shaft with a surface coating layer of a solid lubricant substance.

### FIELD OF THE INVENTION

The present invention relates to a sealing system comprising a rotary sealing surface on a rotary shaft and a rotary shaft lip seal. The present invention also relates to an industrial robot having several axes of rotation, comprising a manipulator with drive units for rotating robot parts according to the axes of rotation of the robot, and in which at least one of said drive units has a rotary shaft provided with the sealing system of the present invention. Further, the invention relates to a method for providing a sealing surface on a rotary shaft.

### BACKGROUND OF THE INVENTION

In some technical applications there is a rotary shaft, such as an output shaft of a motor or gearbox, which needs to be provided with a seal in order to prevent a lubricant, e.g. oil, from leaking out along the shaft. In connection with this, it is common to use a rotary shaft lip seal, which has an annular seal form that surrounds the shaft and is in contact with the circumferential surface of the rotary shaft.

In order for the rotary shaft lip seal to have a good sealing effect, the surface of the shaft should be smooth. A smooth surface also prevents exaggerated wear of the lip seal. Generally, these shafts are made of metal, such as steel or cast iron. In order to obtain a smooth surface the shaft surface is usually machined in several steps and polished. However, there will still always be a certain amount of surface roughness left.

Further, it is common to add a lubricant to the sealing lip of the lip seal. This could be done in different ways. Sometimes it may be done by way of providing a fluid film of lubricant between the sealing surface on the rotary shaft and the sealing lip of the lip seal, and thereby avoiding direct contact between the sealing lip and the sealing surface. Sometimes it may be done by way of filling remaining grooves and indentations on the sealing surface of the shaft with a lubricant and thereby preventing that the sealing lip is worn down by the unevenness of the sealing surface.

A particular field of application is industrial robots where there are drive units for rotating robot parts according to the different axes of rotation of the robot. These drive units comprise an electric motor and usually some kind of gearbox, and a rotary shaft lip seal is used around the output shaft to prevent oil from leaking out from the gearbox.

### SUMMARY OF THE INVENTION

It is an object of the present invention to provide an improved sealing system for a rotary shaft. It is also an object to provide a method for providing an improved sealing surface on a rotary shaft, and a further object is to provide an industrial robot having an improved sealing system for its drive units. These objects are achieved by the sealing system, the industrial robot and the method as defined in the enclosed patent claims.

According to a first aspect of the present invention there is defined a sealing system comprising a rotary sealing surface on a rotary shaft and a rotary shaft lip seal, characterized in that the rotary sealing surface has a surface coating layer of a solid lubricant substance. The surface coating with the solid lubricant will have the effect of making the rotary sealing surface more even by filling out grooves and pits in the sealing surface. Through this is achieved the advantage that the lip seal is exposed to less wear and will have a longer life time. The risk for leakage is thereby reduced. There will also be less friction between the sealing surface of the rotary shaft and lip seal when the shaft rotates. Overall the invention results in advantages both from an economic and a safety point of view.

According to one feature, the rotary sealing surface may comprise a pattern of grooves adapted for retention of an oil or grease lubricant, and an interior of said grooves is also coated with said surface coating layer. By grooves is here intended also cavities that do not necessarily have an elongated shape. By providing the rotary sealing surface with rather deep grooves prior to the coating process, these grooves will also be coated with a thin layer of the deposited coating. However, since the grooves are made deeper than the uneven parts resulting from the machining of the shaft or remaining from the cast of the shaft, which are filled out with the coating, these grooves remain after the coating process having been performed. However, since also the interior and edges of the grooves have been coated, and as a result the grooves will have no sharp edges, there will be much less friction and wear on the sealing lip resulting from the grooves than would be the case with uncoated grooves.

According to another feature, the rotary sealing surface may have a surface coating layer of a tribochemically deposited solid lubricant substance. This may be achieved by using the method and the tool described in WO 009/071674. Preferably, the solid lubricant substance comprises a sulfide of at least one of molybdenum (Mo) and tungsten (W), and more preferably the solid lubricant substance comprises tungsten disulfide (WS₂). According to WO 2009/071674 a tool is provided with a working surface comprising tungsten carbide. The tool is moved over and pressed against a substrate surface to be treated. The substrate surface contains iron atoms or particles. A process fluid comprising sulphur in free form is provided at or in the vicinity of a contact area. In the contact between the working surface of the tool and the substrate surface, a tribofilm is created on the substrate surface by means of tribochemical deposition. In the present case, the substrate surface is the sealing surface of a rotary shaft made of metal, preferably steel or cast iron. After treatment of the sealing surface, a coating is achieved of a nano composite of WS₂. This coating is smeared out in all the unwanted cavities and irregularities of the original surface of the rotary shaft providing an even surface with low friction and high durability.

Also other methods for obtaining a surface coating layer of a solid lubricant, such as the mentioned examples sulphides of molybdenum or tungsten, are conceivable according to the present invention, for example by physical vapour deposition (PVD) coating, chemical vapour deposition (CVD) coating, or using a thermosetting method.

According to a further feature, the surface coating layer may have been deposited in at least two transverse directions along the rotary sealing surface. It may also be an advantage if the surface coating layer has been deposited in a direction that is parallel to the direction of movement of the rotary sealing surface, or at least has a directionality that is parallel to the direction of movement.

According to one embodiment, the sealing system of the present invention may comprise a sealing surface on a rotary shaft that is a shaft of an electric motor.

According to another embodiment, the sealing system of the present invention may comprise a sealing surface on a rotary shaft that is a shaft of a gearbox. As an example, the sealing system of the present invention may comprise a sealing surface on a rotary shaft that is a rotary shaft of a drive unit of an industrial robot.

According to a second aspect of the invention there is defined an industrial robot having several axes of rotation, comprising a manipulator with drive units for rotating robot parts according to the axes of rotation of the robot, and at least one of said drive units having a rotary shaft provided with a sealing system according to any one of the sealing systems described above.

According to a third aspect of the present invention there is defined a method for providing a rotary sealing surface on a rotary shaft, characterized in that it comprises coating the intended sealing surface of the rotary shaft with a surface coating layer of a solid lubricant substance.

According to one feature, the method may comprise providing the rotary sealing surface with a pattern of grooves adapted for retention of an oil or grease lubricant, prior to coating the intended sealing surface of the rotary shaft with a surface coating layer of a solid lubricant substance, such that an interior of said grooves is also coated with said surface coating layer, as well as the edges of the grooves.

According to another feature, the method may include providing the rotary shaft with the surface coating layer by tribochemically depositing the solid lubricant substance. However, as already mentioned above, also other methods are conceivable and the present invention is not limited to tribochemically depositing the solid lubricant system.

The method may comprise providing the surface coating layer in at least two transverse directions along the rotary sealing surface.

According to another feature of the method, the solid lubricant substance may comprise a sulfide of at least one of molybdenum (Mo) and tungsten (W), for example tungsten disulfide (WS₂).

As mentioned, the concerned rotary shafts are usually made of steel or cast iron, but it is conceivable that such shafts may also be made of other metals, e.g. aluminium. The sealing system may not only be used directly on the metal shaft, but it may also be used on the outer sleeve when a rotary shaft is provided with an outer sleeve.

To summarize, the present invention has the advantage of offering a method that is fast since some of the final machining, such as polishing, of a shaft may be made redundant with the new method, it is less expensive and friendly to the environment since it is non-toxic. It provides low friction and high durability and the coating layer of the rotary sealing surface provides good affinity for lubricants.

Further features and advantages of the present invention will become apparent from the following detailed description of the invention.

### BRIEF DESCRIPTION OF THE DRAWINGS

The invention will now be described in more detail, with reference to the appended schematic drawings, illustrating different aspects and embodiments of the invention, given as examples only, and in which:

FIG. 1 shows schematically a sealing system according to the present invention,

FIG. 2a shows schematically a portion of the sealing surface provided with grooves and cavities serving as oil traps, and

FIG. 2b shows schematically the same portion of the sealing surface, after coating with a solid lubricant substance, according to the present invention.

In the drawings, the same elements or corresponding elements in the different embodiments have been given the same reference number.

### DETAILED DESCRIPTION OF THE INVENTION

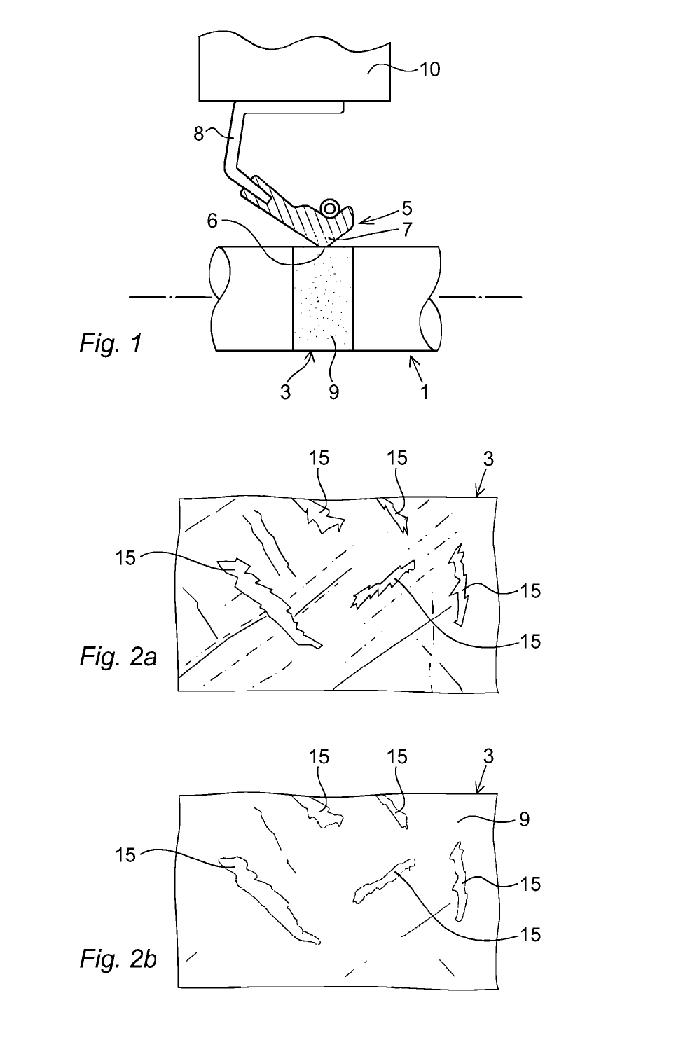

FIG. 1 shows schematically a sealing system according to the present invention, comprising a rotary shaft 1 that has been provided with a sealing surface 3, and also comprising a rotary shaft lip seal 5. The rotary shaft may for example be a rotary shaft of a drive unit in an industrial robot. A housing 10 surrounds the rotary shaft 1. Between the housing and the rotary shaft 1 is arranged the rotary shaft lip seal 5, which comprises a sealing lip 7 of a resilient material, such as an elastomeric material, and a holder arrangement 8 for mounting in the housing 10 and onto which the sealing lip is mounted. The sealing lip 7 has a sealing area 6 that is in contact with the sealing surface 3 of the rotary shaft in order to provide the sealing function. The function of the sealing system is to prevent that oil, or a similar lubricant, present in an enclosed space to the left of the lip seal 5 in FIG. 1, such as a gearbox, leaks out along the rotary shaft and into the space to the right of the lip seal 5 in the FIG. 1.

The sealing surface 3 is a circumferential surface on the rotary shaft which is located in a region of the shaft where the surface of the shaft is expected to be in contact with the sealing area 6 of the sealing lip 7. The lip seal 5 is arranged to surround the shaft 1 and the lip 7 of the lip seal has an annular form such that the sealing area 6 of the lip 7 is in sealing contact with the sealing surface 3 of the rotary shaft at all times.

The rotary sealing surface 3 of the shaft 1 has a surface coating layer 9 of a solid lubricant substance. This solid lubricant substance may for example comprise a sulfide of molybdenum (Mo) and/or tungsten (W), such as a tungsten disulfide (WS₂) or molybdenum disulfide (MoS₂). However, also other solid lubricant substances are conceivable. According to one embodiment, the surface coating layer 9 is obtained by tribochemically depositing the solid lubricant substance on the sealing surface 3 of the rotary shaft 1. This may be achieved by using the method and the tool described in the previously mentioned WO 2009/071674. The tribochemical depositing on the sealing surface may be performed in at least two transverse directions along the surface. It is also conceivable to provide the coating by using some other suitable method, as mentioned above. The thickness of the coating layer 9 may vary depending on how deep the cavities are in the original surface, but as an example the thickness may be in the region of 10 nm to 1 μm.

The sealing surface 3 may also be intentionally provided with a pattern of relatively deep grooves and/or cavities 15 of very small dimensions, which are deep enough to function as oil traps, as illustrated in FIG. 2a. These deep grooves and cavities 15 may for example be produced by a honing process, prior to the coating process. The pattern of grooves may comprise grooves with a depth of 0.1-50 μm, preferably 1-50 μm, or more preferably 1-20 μm, or most preferably 1-10 μm. Alternatively, depending on the properties of the oil or grease lubricant, the grooves may have a preferable depth of 10-50 μm, such as 20-50 μm. In FIG. 2a is also visible a number a lesser cavities, grooves, scratches and marks on the sealing surface which are not deliberately made, but are simply uneven spots present in the original steel surface or cast iron surface which still remain after the usual machining processes.

FIG. 2b shows the same part of the sealing surface as in FIG. 2a, but after having been provided with a surface coating layer 9 in accordance with the present invention. As can be seen, most of the smaller uneven marks are no longer visible after the treatment providing the coating layer, and they have been evened out. However, the deeper grooves and cavities 15 still remain, but their surfaces have now been coated with the solid lubricant such that all rough and sharp edges have been evened out and are now smoother. This will result in lower friction and less wear on the sealing lip 7 cooperating with the coated sealing surface 3, while at the same time there exists a pattern of grooves and cavities 15 which will function to trap oil or grease lubricant.

In the case when the rotary sealing surface 3 has been intentionally provided with grooves and cavities 15 for the purpose of oil retention, prior to depositing the surface coating layer 9, it is important that the thickness of the surface coating layer 9 is adapted to the depth of these grooves and cavities 15 such that the intentionally made grooves and cavities 15 are still present to perform their function after the surface coating layer 9 has been deposited.

In the illustrated example only a part of the shaft surface has been coated, namely a part in the region where the sealing function together with the sealing lip of the rotary shaft lip seal is to be achieved. Naturally, there is nothing to prevent that a major part of the rotary shaft or even the entire shaft is coated with a solid lubricant, if that for example makes the manufacturing process for the rotary shaft more efficient.

The present invention is not limited to the disclosed examples, but may be modified in many ways that would be apparent to the skilled person, within the scope of the appended claims.

1. A sealing system comprising a rotary sealing surface on a rotary shaft and a rotary shaft lip seal, characterized in that the rotary sealing surface has a surface coating layer of a solid lubricant substance.

2. The sealing system according to claim 1, characterised in that the rotary sealing surface comprises a pattern of grooves adapted for retention of an oil or grease lubricant, and that an interior of said grooves is also coated with said surface coating layer.

3. The sealing system according to claim 2, characterized in that the pattern of grooves comprises grooves with a depth of 0.1-50 μm.

4. The sealing system according to claim 1, characterized in that the rotary sealing surface has a surface coating layer of a tribochemically deposited solid lubricant substance.

5. The sealing system according to claim 4, characterized in that the surface coating layer has been deposited in at least two transverse directions along the rotary sealing surface.

6. The sealing system according to claim 1, characterized in that the solid lubricant substance comprises a sulfide of at least one of molybdenum (Mo) and tungsten (W).

7. The sealing system according to claim 6, characterized in that the solid lubricant substance comprises tungsten disulfide (WS₂).

8. The sealing system according to claim 1, characterised in that the rotary shaft is a shaft of an electric motor.

9. The sealing system according to claim 1, characterised in that the rotary shaft is a shaft of a gearbox.

10. An industrial robot having several axes of rotation, comprising a manipulator with drive units for rotating robot parts according to the axes of rotation of the robot, and at least one of said drive units having a rotary shaft provided with a sealing system according to claim 1.

11. A method for providing a rotary sealing surface on a rotary shaft, characterized in that it comprises providing an intended rotary sealing surface on a rotary shaft, providing a pattern of grooves on said intended rotary sealing surface, which grooves are adapted for retention of an oil or grease lubricant, and coating the intended rotary sealing surface of the rotary shaft with a surface coating layer of a solid lubricant substance, such that an interior of said grooves is also coated with said surface coating layer while maintaining their oil or grease lubricant retaining function.

12. The method according to claim 11, characterized in providing the pattern of grooves with a groove depth of 0.1-50 μm.

13. The method according to claim 11, characterized in providing the rotary shaft with the surface coating layer by tribochemically depositing the solid lubricant substance.

14. The method according to claim 11, characterized in providing the surface coating layer in at least two transverse directions along the rotary sealing surface.

15. The method according to claim 11, characterized in that the solid lubricant substance comprises a sulfide of at least one of molybdenum (Mo) and tungsten (W).

16. The method according to claim 15, characterized in that the solid lubricant substance comprises tungsten disulfide (WS2).

17. The sealing system according to claim 2, characterized in that the pattern of grooves comprises grooves with a depth of 1-50 μm.

18. The sealing system according to claim 2, characterized in that the pattern of grooves comprises grooves with a depth of 1-20 μm.

19. The sealing system according to claim 2, characterized in that the pattern of grooves comprises grooves with a depth of 1-10 μm.
